(19) United States
(12) Patent Application Publication
(10) Pub. No.: US 2026/0113322 A1
(43) Pub. Date: Apr. 23, 2026

(54) PRIVATE ENDPOINT PINNING

(71) Applicant: Snowflake Inc., Bozeman, MT (US)

(72) Inventors: A. Emre Kanlikilicer, Campbell, CA (US); Zhen Mo, Cupertino, CA (US); Frantisek Rolinek, Seattle, WA (US); Prasoon Shukla, Sunnyvale, CA (US); Ramana Rao S. Turlapati, Newark, CA (US)

(21) Appl. No.: 18/918,842

(22) Filed: Oct. 17, 2024

(51) Int. Cl. H04L 9/40

(52) U.S. Cl. CPC H04L 63/10

(57) ABSTRACT

A data platform is provided that implements a private endpoint pinning. The method comprises providing a private endpoint service for a set of customer accounts within a database deployment. Upon receiving a request to register a private endpoint of the private endpoint service with a customer account, the data platform verifies ownership and access privileges of the private endpoint. The private endpoint is then pinned to the customer account by registering the pinning in a private account mapping data persistence object. When a data access request is received from the private endpoint for access to the customer account, the data platform verifies the pinning between the private endpoint and the customer account using the registration. Based on this verification, the data access request is allowed.

### TECHNICAL FIELD

Examples of the disclosure relate generally to data platforms and, more specifically, to determining file consistency of database objects.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems. Cloud-based data platforms may communicate data between databases.

### BRIEF DESCRIPTION OF THE DRAWINGS

The present disclosure will be understood more fully from the detailed description given below and from the accompanying drawings of various examples of the disclosure.

FIG. 1 illustrates an example computing environment, according to some examples.

FIG. 2 is a block diagram illustrating components of a compute service manager, according to some examples.

FIG. 3 is a block diagram illustrating components of an execution platform, according to some examples.

FIG. 4 illustrates a malicious attack scenario, according to some examples.

FIG. 5 illustrates a private endpoint registration method, according to some examples.

FIG. 6 illustrates a diagrammatic representation of a machine in the form of a computer system, according to some examples.

### DETAILED DESCRIPTION

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems. Cloud-based data platforms may communicate data between databases.

However, data platforms face security challenges, particularly in shared multi-tenant environments. For example, some data platforms use a shared multi-tenant private link service structure, wherein all accounts within each deployment utilize a single endpoint service provisioned in a load balancer. While this adheres to a shared responsibility security model, it introduces a potential vulnerability to data exfiltration attacks.

The attack scenario unfolds as follows: A malicious insider gains access to a host within the customer's cloud and proceeds to create trial accounts which are in the same deployment as the customer account. Leveraging the compromised host, the attacker establishes a connection to the customer account and initiates downloads of data. Given that the request originates from a legitimate private endpoint, this is permitted. Subsequently, the attacker manipulates the DNS configuration by creating an entry for its account and pointing it to a private IP address of the private endpoint. With the shared private endpoint service, the attacker gains unauthorized access to its trial account, enabling them to upload the exfiltrated data.

Current solutions, such as the shared responsibility model where customers implement firewalls in their cloud environments, can be expensive and impractical for small to medium users. Additionally, existing proof of ownership validation mechanisms for cloud services do not adequately verify that the user generating the token has the necessary access privileges on the private link endpoint or resource.

These vulnerabilities highlight the need for more robust security measures in shared multi-tenant data platform environments, particularly for protecting against data exfiltration attacks and ensuring proper access control for private endpoints.

To address these issues, systems in accordance with the disclosures of this document provide a private endpoint pinning solution that allows customers to securely associate their private endpoints to specific accounts within a database deployment. The system implements enhanced ownership verification using cloud-specific identifiers and authentication mechanisms, such as federated tokens with specific permissions. The systems may also provide for a delayed enforcement feature, allowing customers to set up pinning of endpoints across multiple accounts without interrupting workflows. Such systems can include system functions for registering, unregistering, and managing private endpoint pinning, as well as additional verification steps for data access requests. By implementing this private endpoint pinning approach, the systems mitigate the risk of unauthorized access and potential data exfiltration attacks in shared multi-tenant environments, while maintaining performance through efficient caching mechanisms.

In some examples, a data platform provides a private endpoint service for a set of customer accounts within a database deployment. Upon receiving a request to register a private endpoint of the private endpoint service with a customer account, the data platform verifies ownership and access privileges of the private endpoint. The private endpoint is then pinned to the customer account by registering the pinning in a private account mapping data persistence object. When a data access request is received from the private endpoint for access to the customer account, the data platform verifies the pinning between the private endpoint and the customer account using the registration. Based on this verification, the data access request is allowed.

In some examples, the data platform receives a federated token from a customer of the customer account, validates the federated token using a cloud-specific authentication, and confirms that the token grants access to the private endpoint.

In some examples, the data platform provides system-level functions for managing private endpoint registrations, including at least one of a private endpoint registration function, an unregister private endpoint function, and a get private endpoint registration function. These system-level functions allow customers to manage their connections to the private endpoint service.

In some examples, the data platform creates the pinning by associating a cloud-specific identifier of the private endpoint with a customer account identifier of the customer account. This association allows the data platform to uniquely identify and link a specific private endpoint to a particular customer account within the shared multi-tenant environment of the data platform.

In some examples, the data platform delays enforcement of the pinning using a specified time period between registering the pinning and enforcement of the pinning. This delayed enforcement feature addresses potential issues that may arise when customers have a private endpoint pinned to multiple customer accounts.

In some examples, the data platform verifies the pinning between the private endpoint and the customer account by extracting a request private endpoint identifier and a request customer account identifier from a header of the data access request, and querying the private account mapping data persistence object using the request private endpoint identifier and the request customer account identifier to determine if the request private endpoint identifier is pinned to the request customer account identifier. This process allows the system to validate whether the private endpoint associated with the data access request is authorized to access the specified customer account.

In some examples, the data platform caches frequently accessed registrations in a time-limited cache. This caching mechanism is implemented to improve performance and efficiency of the private endpoint pinning solution. By using a time-limited cache to store the mapping from the private endpoint identifier to the customer account identifier, the data platform can lower the probability of causing transactions to expire when verifying the pinning between private endpoints and customer accounts.

In some examples, the private account mapping data persistence object includes a first slice for mapping pinned consumer endpoint identifiers to customer account identifiers, and a second slice for mapping customer account identifiers to pinned consumer endpoint identifiers. The first slice stores associations between cloud-specific identifiers of private endpoints (such as VPCE-IDs or link identifiers) and the corresponding customer account identifiers. The first slice allows the system to efficiently look up which customer account is associated with a given private endpoint.

The second slice provides a reverse lookup capability by mapping account identifiers to their associated private endpoints. This complementary structure enables the data platform to quickly determine how many pinned private endpoints exist for a given customer account. Together, these two slices facilitate efficient management and verification of private endpoint registrations, enhancing the security and performance of the private endpoint pinning solution in the shared multi-tenant environment.

In some examples, the data platform implements the pinning methodologies using cloud-specific identifiers and authentication processes for the private endpoint in a multi-cloud environment. This approach allows the data platform to maintain a consistent private endpoint pinning solution while accommodating the unique characteristics and authentication methods of different cloud environments.

In some examples, the data platform receives a delay time parameter from the customer during a registration process, calculates an enforcement timestamp based on a current time and the delay time parameter, and activates the enforcement of the pinning on a per-customer basis when the current time exceeds the enforcement timestamp. This delayed enforcement mechanism allows customers to specify a time delay duration during the registration process.

Reference will now be made in detail to specific examples for carrying out the inventive subject matter. Examples of these specific examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

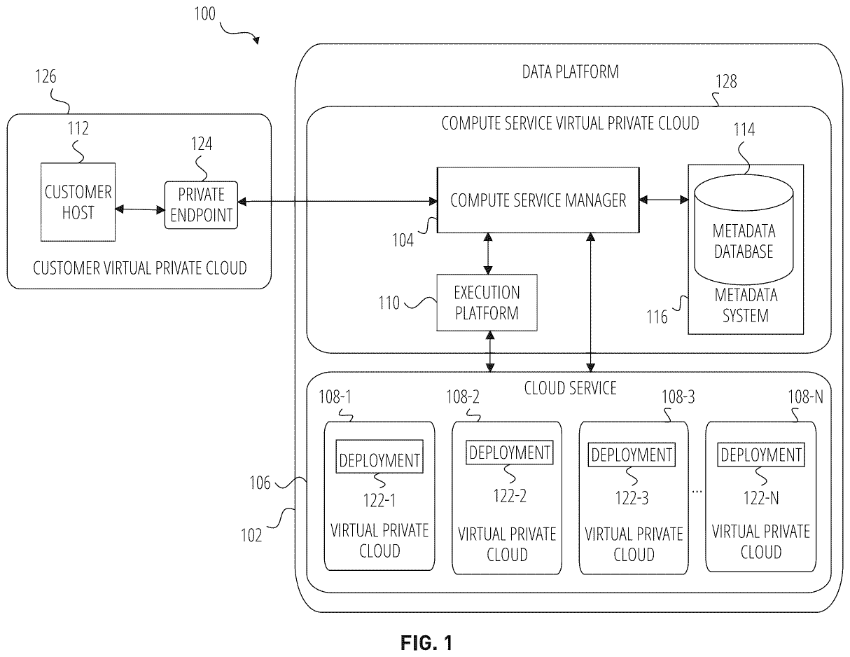

FIG. 1 illustrates an example computing environment 100 that includes a data platform 102 in communication with a customer host 112, according to some examples. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a compute service manager 104, an execution platform 110, and a metadata system 116. The 102 is in communication with a cloud service 106 can comprise a plurality of computing machines and provides on-demand computer system resources such as data storage and computing power to the data platform 102. As shown, the cloud service 106 comprises one or more Virtual Private Clouds (VPCs), such as virtual private cloud 108-1, virtual private cloud 108-2, virtual private cloud 108-3, to virtual private cloud 108-N.

In some examples, the cloud service 106 is located in one or more geographic locations. For example, the virtual private clouds 108-1 to 108-N may be part of a public cloud infrastructure or a private cloud infrastructure. The virtual private clouds 108-1 to 108-N may comprise hard disk drives (HDDs), solid state drives (SSDs), storage clusters, Amazon S3™ storage systems or any other data storage technology. Additionally, the cloud service 106 may include distributed file systems (e.g., Hadoop Distributed File Systems (HDFS)), object storage systems, and the like.

In some examples, a virtual private cloud is a secure, isolated virtual network within a public cloud environment that allows organizations to run and manage their cloud resources with enhanced control and privacy. A virtual private cloud can provide the functionality of a traditional data center without the physical management and maintenance overhead, enabling users to define their own network space. This includes selecting IP address ranges, creating subnets, configuring router tables, and setting up network gateways. Virtual private clouds are beneficial for entities that desire a partitioned section of a cloud to ensure that their applications and data are isolated from other users on the same public cloud platform. This isolation helps in maintaining security and compliance with regulatory requirements, while also allowing for scalable and flexible resource management.

In some examples, data objects are stored in structured data files. The structured data files can be in various structured file formats such as, but not limited to, Comma-Separated Values (CSV) JavaScript Object Notation (JSON), Apache Avro (Avro), Apache Parquet (Parquet) Optimized Row Columnar (ORC), Extensible Markup Language (XML), and the like.

In some examples, the data platform 102 organizes data storage using micro-partitions of a database table using a suitable structured data file format specifically designed for optimal performance and security within the computing environment 100 such as, but not limited to, Flocon De Neige (FDN) and the like. Whenever new data is added to a table, new micro-partition files are created. This approach ensures that data is stored in an immutable format where the addition of a new record results in the generation of a new micro-partition file.

The data platform 102 is used for reporting and analysis of integrated data from one or more disparate sources including the virtual private clouds 108-1 to 108-N within the data cloud service 106. The data platform 102 hosts and provides data reporting and analysis services to multiple customer accounts. Administrative users can create and manage identities (e.g., users, roles, and groups) and use privileges to allow or deny access to identities to resources and services. Generally, the data platform 102 maintains numerous customer accounts for numerous respective customers.

The data platform 102 maintains each customer account in the one or more virtual private clouds of the cloud service 106. In some examples, the customer accounts are included in one or more database deployments stored of the virtual private clouds 108-1 to 108-N, such as respective deployment 122-1, deployment 122-2, deployment 122-3, and deployment 122-N.

In some examples, components of the data platform 102 such as, but not limited to, the compute service manager 104 and the execution platform 110, access data storage systems of the cloud service 106 directly as Platform-as-a-Service (PaaS) through Cloud Platform APIs. This architecture allows for flexible and scalable access to storage resources without requiring direct management of the underlying infrastructure.

In some examples, the data platform 102 may maintain metadata associated with the customer accounts in the metadata database 114 of the metadata system 116. Each customer account includes multiple objects with examples including users, roles, privileges, a datastores or other data locations.

The compute service manager 104 coordinates and manages operations of the data platform 102. The compute service manager 104 also performs query optimization and compilation as well as managing clusters of compute services that provide computation resources (also referred to as “virtual warehouses”). The compute service manager 104 can support any number and type of clients such as end users providing data storage and retrieval requests, system administrators managing the systems and methods described herein, and other components/devices that interact with compute service manager 104. As an example, the compute service manager 104 is in communication with the customer host 112. The customer host 112 can be used by a user of one of the multiple customer accounts supported by the data platform 102 to interact with and utilize the functionality of the data platform 102. In some examples, the compute service manager 104 does not receive any direct communications from the customer host 112 and only receives communications concerning jobs from a queue within the data platform 102.

The compute service manager 104 is also coupled to metadata database metadata system 116. The metadata system 116 includes a metadata database 114 that stores metadata pertaining to various functions and examples associated with the data platform 102 and its users. In some examples, the metadata database 114 includes a summary of data stored in remote data storage systems as well as data available from a local cache. In some examples, the metadata database 114 may include information regarding how data is organized in remote data storage systems (e.g., the cloud service 106) and the local caches. In some examples, the metadata database 114 includes data of metrics describing usage and access by data platform customers including provider users who provide data for use by consumer users of the data stored on the data platform 102. In some examples, the metadata database 114 allows systems and services to determine whether a piece of data needs to be accessed without loading or accessing the actual data from a storage system such as a virtual private cloud of cloud service 106.

The compute service manager 104 is further coupled to the execution platform 110, which provides multiple computing resources that execute various data storage and data retrieval tasks. The execution platform 110 is coupled to the cloud service 106. The execution platform 110 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle communication with a compute cluster for a given job provided by the compute service manager 104 and to communicate information back to the compute service manager 104 and other compute nodes of the execution platform 110.

In some examples, a customer may use the customer host 112 within a customer virtual private cloud to access customer accounts of a deployment, such as deployment 122-1, of the data platform 102 using a private endpoint 124. The private endpoint 124 is a network interface that connects the customer host 112 privately and securely to the data platform 102. The private endpoint 124 allows the data platform 102 to implement a private link as a connection between the customer virtual private cloud 126 and the computer service virtual private cloud 128 of the data platform 102 that provides the private endpoint service. This architecture allows for secure, private connectivity between a customer's cloud environment and the data platform 102. The private endpoint 124 in the customer virtual private cloud 126 connects to the private endpoint service in the private endpoint service in the compute service virtual private cloud 128, enabling authorized access to data platform accounts and resources while maintaining network isolation.

In some examples, the customer host 112 communicates a data access request to the compute service manager 104. The data access request includes a private endpoint identifier identifying the private endpoint 124 and a customer account identifier identifying the customer account. The compute service manager 104 receives the data access request and uses a private endpoint service to establish access to the customer account via the private endpoint 124.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the virtual private clouds 108-1 to 108-N are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the virtual private clouds supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata system 116, execution platform 110, and data cloud service 106 are shown in FIG. 1 as individual discrete components. However, each of the compute service manager 104, metadata system 116, execution platform 110, and data cloud service 106 may be implemented as a distributed system (e.g., distributed across multiple systems/platforms at multiple geographic locations). Additionally, each of the compute service manager 104, metadata system 116, execution platform 110, and cloud service 106 can be scaled up or down (independently of one another) depending on changes to the requests received and the changing needs of the data platform 102. Thus, in the described examples, the data platform 102 is dynamic and supports regular changes to meet the current data processing needs.

During operation, the data platform 102 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 110 to process the task. The compute service manager 104 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 104 in determining which nodes in the execution platform 110 have already cached at least a portion of the data needed to process the task. One or more nodes in the execution platform 110 process the task using data cached by the nodes and, if necessary, data retrieved from the cloud service 106. It is desirable to retrieve as much data as possible from caches within the execution platform 110 because the retrieval speed is typically faster than retrieving data from the cloud service 106.

As shown in FIG. 1, the computing environment 100 separates the execution platform 110 from the cloud service 106. In this arrangement, the processing resources and cache resources in the execution platform 110 operate independently of the virtual private clouds 108-1 to 108-N of the cloud service 106. Thus, the computing resources and cache resources are not restricted to a specific one of the virtual private clouds 108-1 to 108-N. Instead, computing resources and cache resources may retrieve data from, and store data to, any of the data storage resources in the cloud service 106.

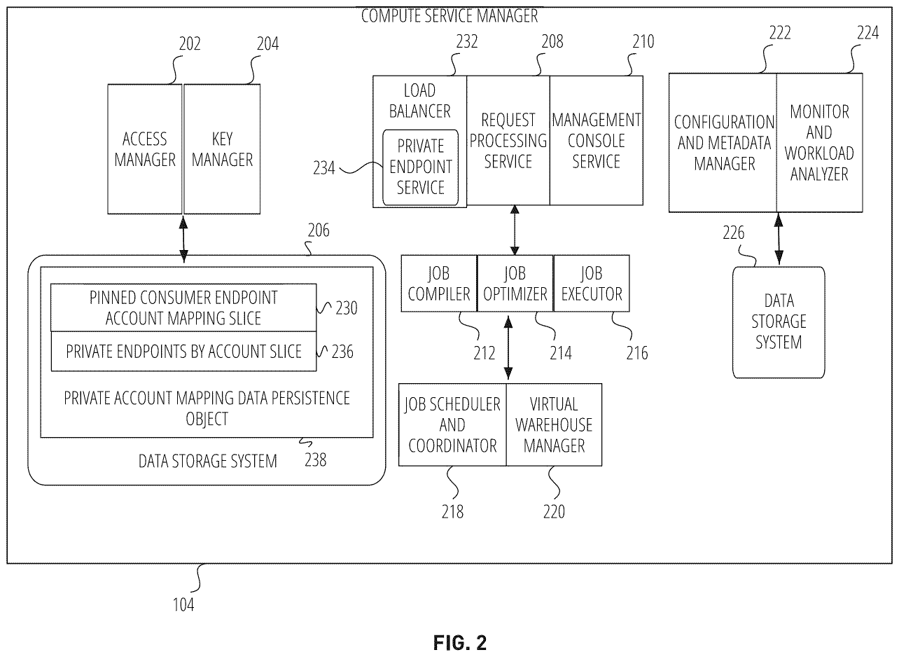

FIG. 2 is a block diagram illustrating components of the compute service manager 104, according to some examples. As shown in FIG. 2, the compute service manager 104 includes an access manager 202, and a key manager 204. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage systems (e.g., virtual private clouds in a cloud service). As used herein, the remote storage systems may also be referred to as “persistent storage systems” or “shared storage systems.”

In some examples, the access manager 202 operates within a data platform to control access to various objects of the data platform using Role-Based Access Control (RBAC). The access manager 202 is a component that manages authentication and authorization tasks, providing for authorized entities to access specific resources within the data platform. This component plays a role in maintaining the security and integrity of the data platform by enforcing access policies defined through RBAC.

In some examples, RBAC is implemented by defining roles within the data platform, where each role is associated with a specific set of permissions. These permissions determine the actions that entities assigned to the role can perform on various objects within the data platform. The access manager 202 utilizes these roles to make access control decisions, allowing or denying requests based on the roles assigned to the requesting entity and the permissions associated with those roles.

In some examples, the data platform creates specific access roles based on a manifest of an application received from an application package. These access roles are activated by the access manager 202 and are used to govern access to objects used by the application during operation. For example, an access role may grant the application the ability to create a compute pool and execute a service within that compute pool. The access manager 202 provides that an application, or entities authorized by the application, can perform actions permitted by the access role.

In some examples, the access manager 202 also controls access to objects of the data platform using the access roles during the execution of the service within the compute pool. The service accesses objects of the data platform under the governance of the activated access roles. The access manager 202 checks the permissions associated with the access roles against the access requests made by the service, granting or denying these requests based on the defined RBAC policies.

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a virtual private cloud of cloud service 106.

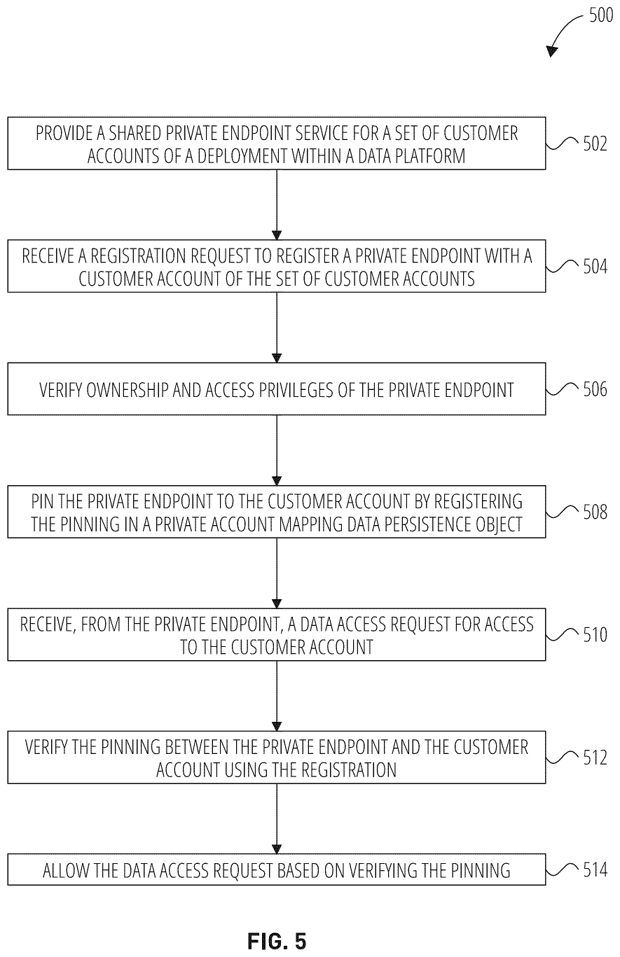

In some examples, the compute service manager 104 processes incoming data access requests using a request processing service 208, which manages received data storage and retrieval requests. Before allowing access, the compute service manager 104 verifies a pinning between private endpoints of a deployment and the deployment's customer accounts using a registered pinning stored in a private account mapping data persistence object 238. In some examples, pinning is process of associating a private endpoint to a specific customer account within a shared multi-tenant environment of the data platform and registering the association as a pinning. For example, a pinning process includes associating a cloud-specific identifier of the private endpoint (e.g., a Virtual Private Cloud Endpoint-IDentifier (VPCE-ID), a link identifier, or the like) with a customer account identifier of a customer account of the data platform and storing the association of the private endpoint and the customer account in a private account mapping data persistence object 238. The private account mapping data persistence object 238 can include two slices: a pinned consumer endpoint account mapping slice 230 that maps pinned consumer endpoint identifiers to customer account identifier and a private endpoints by account slice 236 that maps customer account identifiers to pinned consumer endpoint identifiers. The purpose of pinning is to enhance security by ensuring that only authorized private endpoints can access their designated customer accounts. When a data access request is received from a private endpoint, the system verifies the pinning between the private endpoint and the customer account using the registered association before allowing the data access request as more fully described in reference to FIG. 5. If the pinning is verified, the compute service manager 104 allows the data access request and the request processing service 208 routes the data access request to the appropriate components within the data platform 102.

In some examples, the compute service manager 104 employs additional security measures, such as verifying ownership and access privileges of the private endpoints, to prevent unauthorized access or potential data exfiltration attacks. This secure access methodology ensures that only authorized customer hosts can access their designated customer accounts through the registered private endpoints, mitigating the risk of unauthorized access to other customer accounts within the shared multi-tenant environment.

A load balancer 232 distributes incoming network or application traffic across multiple nodes of an execution platform, such as execution platform 110 of FIG. 1. This distribution ensures that no single node becomes overwhelmed with requests, optimizing resource utilization and enhancing overall performance. In some examples, the load balancer 232 includes one or more private endpoint services, such as private endpoint service 234. The private endpoint service 234 provides access to one or more customer accounts in one or more deployments, such as deployments 122-1 to 122-N of FIG. 1. Provisioning of a private endpoint service is more fully described in reference to FIG. 5.

In some examples, the compute service manager 104 controls access to the private endpoint service 234 using the access manager 202 that maintains a pinned consumer endpoint account mapping slice 230 associating individual customer accounts with private endpoints as more fully described in reference to FIG. 5.

A management console service 210 supports access to various systems and processes by administrators and other system managers. Additionally, the management console service 210 may receive a request to execute a job and monitor the workload on the system.

The compute service manager 104 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 104.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 determines a priority for internal jobs that are scheduled by the compute service manager 104 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

Additionally, the compute service manager 104 includes a configuration and metadata manager 222, which manages the information related to the data stored in remote data storage systems such as, but not limited to, VPCs and the like and in the local caches (e.g., the caches in execution platform 110). The configuration and metadata manager 222 uses the metadata to determine which data micro-partitions need to be accessed to retrieve data for processing a particular task or job. A monitor and workload analyzer 224 oversees processes performed by the compute service manager 104 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage system 226. Data storage system 226 in FIG. 2 represents any data storage system of the data platform 102. For example, data storage system 226 may represent caches in execution platform 110, virtual private clouds of cloud service 106, or any other storage system or device.

The compute service manager 104 validates communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage system 226) that is not relevant to query A. Similarly, a given execution node (e.g., execution node 304a) may need to communicate with another execution node (e.g., execution node 304b), and should be disallowed from communicating with a third execution node (e.g., execution node 316a) and any such illicit communication can be recorded (e.g., in a log or other location). Also, the information stored on a given execution node is restricted to data relevant to the current query and any other data is unusable, rendered so by destruction or encryption where the key is unavailable.

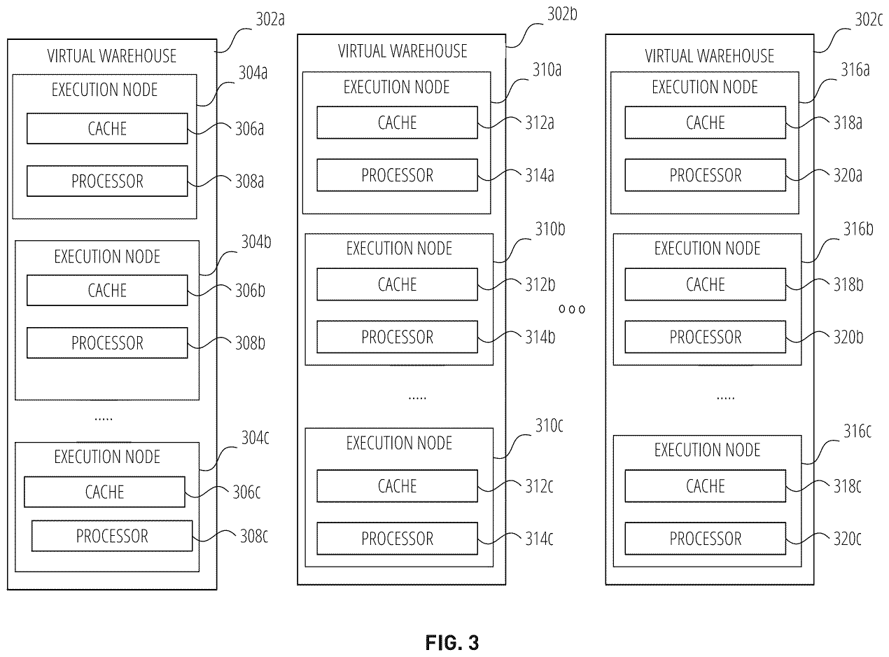

FIG. 3 is a block diagram illustrating components of the execution platform 110, according to some examples. As shown in FIG. 3, the execution platform 110 includes multiple virtual warehouses, including virtual warehouse 302a, and virtual warehouse 302b to virtual warehouse 302c. Each virtual warehouse includes multiple execution nodes that each includes a data cache and a processor. The virtual warehouses can execute multiple tasks in parallel by using the multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. Virtual warehouses can access data from any data storage system (e.g., any virtual private cloud of cloud service 106).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the virtual private clouds 108-1 to 108-N shown in FIG. 1. Thus, the virtual warehouses are not necessarily assigned to a specific virtual private cloud 108-1 to 108-N and, instead, can access data from any of the virtual private clouds 108-1 to 108-N within the cloud service 106. Similarly, each of the execution nodes shown in FIG. 3 can access data from any of the virtual private clouds 108-1 to 108-NN. In some examples, a particular virtual warehouse or a particular execution node may be temporarily assigned to a specific virtual private cloud, but the virtual warehouse or execution node may later access data from any other virtual private cloud.

In the example of FIG. 3, virtual warehouse 302a includes a plurality of execution nodes as exemplified by execution node 304a, execution node 304b, and execution node 304c. Execution node 304a includes cache 306a and a processor 308a. Execution node 304b includes cache 306b and processor 308b. Execution node 304c includes cache 306c and processor 308c. Each execution node 1 to N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 302a discussed above, virtual warehouse 302b includes a plurality of execution nodes as exemplified by execution node 310a, execution node 310b, and execution node 310c. Execution node 304a includes cache 312a and processor 314a. Execution node 310b includes cache 312b and processor 314b. Execution node 310c includes cache 312c and processor 314c. Additionally, virtual warehouse 302c includes a plurality of execution nodes as exemplified by execution node 316a, execution node 316b, and execution node 316c. Execution node 316a includes cache 318a and processor 320a. Execution node 316b includes cache 318b and processor 320b. Execution node 316c includes cache 318c and processor 320c.

In some examples, the execution nodes shown in FIG. 3 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate examples may include execution nodes containing any number of processors and any number of caches. Additionally, the caches may vary in size among the different execution nodes. The caches shown in FIG. 3 store, in the local execution node, data that was retrieved from one or more virtual private clouds of cloud service 106. Thus, the caches reduce or eliminate the bottleneck problems occurring in platforms that consistently retrieve data from remote storage systems. Instead of repeatedly accessing data from the virtual private clouds, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the virtual private clouds in the cloud service 106.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse as shown in FIG. 3 has multiple execution nodes. The multiple execution nodes associated with each virtual warehouse may be implemented using multiple computing systems at multiple geographic locations. For example, an instance of virtual warehouse 302a implements execution node 304a and execution node 304b on one computing platform at a geographic location and implements execution node 304c at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in cloud service 106, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

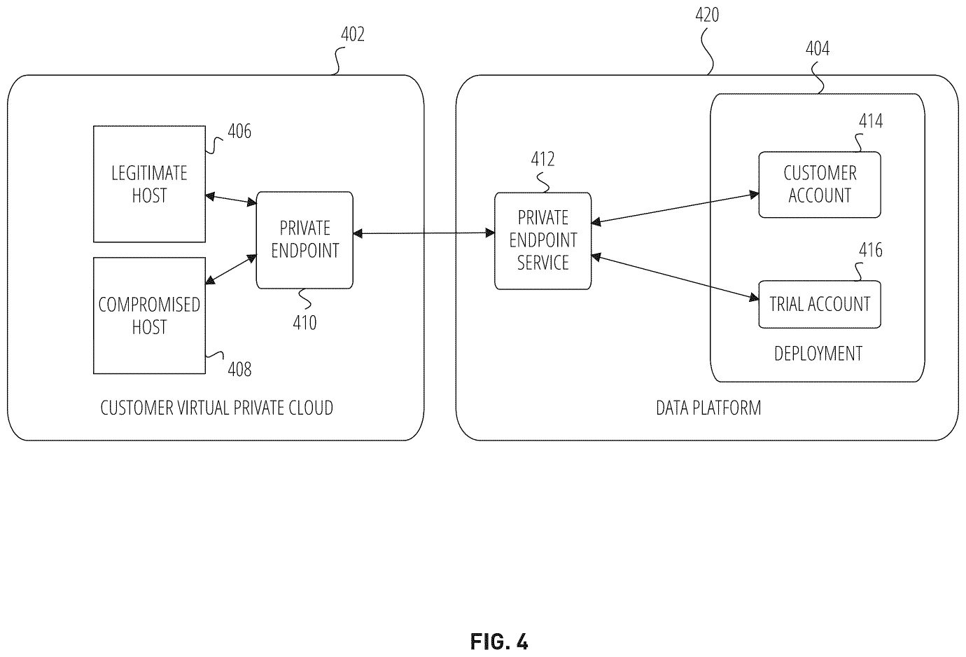

FIG. 4 is a diagram illustrating a malicious attack scenario, according to some examples. A data platform 420 provides a shared private endpoint service 412 that a customer uses to access a customer account 414 using a legitimate host 406. The private endpoint service 412 provides connectivity to a deployment 404 on the data platform 420 via a private endpoint 410. The private endpoint 410 is shared by multiple customer accounts within the deployment 404. This shared structure adheres to a shared responsibility security model but introduces a potential vulnerability to data exfiltration attacks. The attack scenario unfolds as follows:
A malicious insider gains access to a compromised host 408 within the customer cloud 402 and creates a trial account 416 in the data platform 420 within the same deployment 404 as the legitimate customer account 414.
Using the compromised host 408, the attacker establishes a connection to the customer account 414 using the private endpoint 410 and initiates a data download using the private endpoint service 412. This is permitted because the request originates from a legitimate private endpoint 410.
The attacker then manipulates a DNS configuration, creating an entry for their malicious account 416 that points to the private IP address of the private endpoint 410. Leveraging the shared private endpoint 410, the attacker gains unauthorized access to their trial account 416 enabling them to upload the exfiltrated data.

This illustrates a potential vulnerability in the shared multi-tenant private endpoint service structures, where a compromised host 408 within the customer cloud 402 can potentially access both a legitimate customer account 414 and an unauthorized trial account 416 through the same private endpoint 410.

FIG. 5 illustrates an example private endpoint registration method 500, according to some examples. Although the example private endpoint registration method 500 depicts a particular sequence of operations, the sequence may be altered without departing from the scope of the present disclosure. For example, some of the operations depicted may be performed in parallel or in a different sequence that does not materially affect the function of the private endpoint registration method 500. In other examples, different components of a data platform that implements the private endpoint registration method 500 may perform functions at substantially the same time or in a specific sequence.

In operation 502, a data platform provides a shared private endpoint service for a set of customer accounts of a deployment of the data platform. For example, in reference to FIG. 2, a compute service manager 104 of the data platform configures a load balancer 232 to distribute traffic to services provided by the data platform. To do so, the compute service manager 104 uses data storage system APIs or SDKs to create the private endpoint service 234 linking to a cloud service 106 of FIG. 1 and associates the private endpoint service 234 with the load balancer 232. This enables secure, private connectivity between the customer accounts associated with deployments on the cloud service 106 and the data platform.

In operation 504, the compute service manager 104 receives a registration request to register a private endpoint with a customer account of the set of customer accounts. For example, a customer account administrator uses a customer host to communicate a registration request to register a private endpoint with the data platform. The private endpoint will be used by the users of the customer to access one or more user accounts in a deployment on a data storage system of the data platform. In some examples, the data platform provides a system-level private endpoint registration function for pinning a private endpoint to a customer account. The private endpoint registration function allows customers to associate their private endpoints to specific customer accounts, thereby mitigating the risk of unauthorized access and potential data exfiltration attacks in a shared multi-tenant environment. The private endpoint registration function takes input parameters such as, but not limited to, a pinned consumer endpoint identifier, a consumer endpoint identifier, and a federated token. The pinned consumer endpoint identifier is a cloud-specific identifier of a private endpoint provided by a cloud service such as, but not limited to, a VPCE-ID, a link identifier, or the like. The cloud-specific identifier is used to uniquely identify the private endpoint that is being pinned to a customer account.

The consumer endpoint identifier is a field that serves a different purpose depending on the cloud service provider providing the cloud service of the private endpoint. In some examples, the consumer endpoint identifier holds an account identifier of an account on the cloud service. In additional examples, the consumer endpoint identifier holds a link identifier of a resource on the cloud service. In some examples, the consumer endpoint identifier may lack the granularity required to specify a private endpoint effectively. The pinned consumer endpoint identifier allows for more precise identification and pinning private endpoints to customer accounts.

The federated token is used to verify the ownership and access privileges of the private endpoint during the registration process. Federated tokens are used for authentication and authorization across different systems or domains. They allow for secure, temporary access to resources without sharing long-term credentials. For some cloud services, the federated token is generated with specific policies that grant permissions to describe Virtual Private Cloud (VPC) endpoints. For some cloud services, the token grants access to specific resources. This approach allows for fine-grained control over what actions a token holder can perform, enhancing security in the cloud environment.

In some examples, a federated token follows a security principle of least privilege, where users are given only the permissions necessary to perform their required tasks. This approach helps mitigate potential security risks in a shared multi-tenant environment of cloud-based services.

In some examples, the private endpoint registration function is restricted by RBAC, allowing only roles with account modification privileges to execute the private endpoint registration function.

In operation 506, the compute service manager verifies ownership and access privileges of the private endpoint. For example, the private endpoint registration function verifies the ownership of the private endpoint using the provided federated token. This verification step ensures that only authorized users can register a private endpoint with their account. In some examples, the customer generates a federated token with a policy that allows an action of describing the private endpoint by the cloud service providing the private endpoint. The action includes a specific permission granted by the cloud service that allows a user or role to list and describe VPC endpoints in a cloud service account. This action is used as part of the proof of ownership validation process for the cloud service. During the verification process, compute service manager uses the action associated with the federated token to attempt to describe the VPC endpoints in the customer's cloud service account. This allows the compute service manager to confirm that a pinned consumer endpoint identifier provided in the registration request actually exists and is owned by the customer. By successfully executing this action, the compute service manager can verify that a user registering a private endpoint has the necessary permissions and ownership of the specified private endpoint. This approach provides a secure method for validating endpoint ownership without requiring the data platform to have direct access to the customer's cloud service account, thus maintaining the principle of least privilege and enhancing overall security in the private endpoint pinning process.

In some examples, a customer generates a federated token that can access a specific resource of a cloud service. During the verification process, the private endpoint registration function attempts to access the specific resource to confirm that the token owner has the necessary privileges. This verification process directly verifies access to the specific resource rather than checking for a particular permission. This method aligns with some cloud service's resource-based access control model and provides a robust way to confirm ownership and access rights to the private endpoint being registered.

In operation 508, compute service manager pins the private endpoint to the customer account by registering the pinning in a private account mapping data persistence object. For example, in reference to FIG. 2, the private endpoint registration function adds a private account mapping data persistence object 238 to a data storage system 206 of the compute service manager 104. The private account mapping data persistence object 238 has a pinned consumer endpoint account mapping slice 230 and a private endpoints by account slice 236.

A pinned consumer endpoint account mapping slice can include, but is not limited to:
A pinned consumer endpoint identifier that stores a cloud-specific identifier of the private endpoint such as, but not limited to, VPCE-ID, a link identifier, or the like.
An account identifier storing a customer account identifier of a customer account associated with the cloud-specific identifier stored in the pinned consumer endpoint identifier.
A provider private service endpoint that is an identifier of a shared private endpoint service provided by the data platform for each deployment.
A consumer endpoint identifier type indicating a cloud service provider providing the private endpoint.

A private endpoints by account slice can include, but is not limited to:
The account identifier as a first key, allowing for efficient lookup of private endpoints associated with a specific customer account.
The provider private service endpoint referring to the shared private endpoint service provided by the data platform for each deployment.
The consumer endpoint identifier type indicating the cloud service provider being used for the private endpoint.
A consumer endpoint identifier that stores a cloud-specific account identifier of the cloud service account of the private endpoint.
The pinned consumer endpoint identifier that stores the cloud-specific identifier of the private endpoint such as a VPCE-ID, link identifier, or the like.

The private endpoints by account slice maps account identifiers to their associated private endpoints, allowing for efficient lookup of how many pinned private endpoints exist in the current account. It complements the pinned customer pinned consumer endpoint account mapping by providing a reverse lookup capability, which is useful for managing and verifying private endpoint registrations for each account.

In some examples, the private endpoint registration function assumes that the private service endpoint has already been enabled for an account that a customer for which a customer is attempting register a private endpoint. As a precautionary measure, compute service manager checks if the data persistence object exists in a primary slice before proceeding with the registration process. This check helps prevent duplicate registrations and ensures data consistency.

By allowing customers to pin their private endpoints to specific customer accounts through the private endpoint registration process, the data platform enhances overall security in the shared multi-tenant environment. Such registrations mitigate the risk of unauthorized access and potential data exfiltration attacks by ensuring that requests from a private endpoint are only routed to the customer accounts to which they have been explicitly pinned.

In some examples, the data platform delays enforcement of a pinning using a specified time period between registering the pinning and enforcement of the pinning. This delayed enforcement feature addresses potential issues that may arise when customers have multiple accounts accessing the same private endpoint. For example, the private endpoint registration function includes a delay time parameter. This delay time parameter allows customers to specify a duration (e.g., between 0 and 1440 minutes, with a default of 60 minutes) by which enforcement of the pinning for data access will be delayed for all customer accounts within a deployment. In some examples, a value of the delay time parameter is stored in the private account mapping data persistence object.

The compute service manager receives the delay time parameter from the customer during a registration process, calculates an enforcement timestamp based on a current time and the delay time parameter, and activates the enforcement of the pinning on a per-customer account basis when the current time exceeds the enforcement timestamp. In some examples, the compute service manager calculates an enforcement timestamp for each customer account by adding the value of the delay time parameter to a current timestamp. The enforcement timestamp is stored as a new property in the private account mapping data persistence object. When loading a cache or processing requests, the data platform compares the current timestamp with the enforcement timestamp for each account. The enforcement of the pinning is activated on a per-customer account basis when the current time exceeds the enforcement timestamp.

This delayed enforcement mechanism provides customers with a grace period to register all their relevant customer accounts with the same private endpoint before the pinning is enforced. It helps prevent unintended blocking of traffic to legitimate accounts during the setup process, allowing for a smoother transition to the enhanced security model.

In some examples, the data platform provides a system-level unregister private endpoint function designed to remove a pinning between a private endpoint and a customer account. Similarly to the private endpoint registration function, the unregister private endpoint function has three input parameters: a pinned consumer endpoint identifier, a consumer endpoint identifier, and a federated token. In some examples, the unregister private endpoint function is restricted by RBAC, allowing only roles with modify account privileges to execute the unregister private endpoint function. In some examples, the unregister private endpoint function verifies the ownership of the private endpoint using the provided federated token as previously described. This verification step ensures that only authorized users can unregister a private endpoint from their account. If the verification is successful, the function removes the corresponding private account mapping data persistence object from the pinned consumer endpoint account mapping slice and the private endpoints by account slice. The unregister private endpoint function allows customers to remove a binding between their private endpoints and specific accounts when needed. This flexibility facilitates managing access control and maintaining security in the shared multi-tenant environment.

In some examples, a data platform provides a system-level get private endpoint registration function allowing retrieval of information about registered private endpoints for an account. The get private endpoint registration function takes no input parameters and returns registered private endpoints information as output. Like the other system-level functions related to private endpoint management, the get private endpoint registration function is restricted by RBAC to only allow roles with modify account privileges to execute the get private endpoint registration function. When executed, the get private endpoint registration function retrieves all private account mapping data persistence objects from the pinned consumer endpoint account mapping slice and the private endpoints by account slice that are registered for the current account.

In some examples, to obtain a pinned consumer endpoint identifier, customers can execute a separate system-level get private endpoint identifier to retrieve a cloud-specific identifier for a private endpoint associated with the customer's account.

In some examples, the data platform exposes the system-level functions as APIs to allow customers to manage their connections to the private endpoint service.

In operation 510, the compute service manager receives, from a customer via the private endpoint, a data access request for access to the customer account and, in operation 512, the compute service manager verifies a pinning between the private endpoint and the customer account using the registrations stored in the private account mapping data persistence object. For example, the data access request includes a header including a private endpoint identifier identifying the private endpoint associated with the data access request and a customer account identifier identifying the customer account associated with the data access request. A request processing service 208 of FIG. 2 of the compute service manager receives the data access request and extracts the private endpoint identifier and the customer account identifier from the header of the data access request. The request processing service 208 queries the private account mapping data persistence object 238 to determine if the extracted private endpoint identifier is pinned to the extracted customer account.

In operation 514, the compute service manager allows the data access request based on the verification of the pinning. For example, if a private endpoint associated with the data access request is pinned to a customer account associated the data access request, the data access request is deemed legitimate and allowed to proceed. If the private endpoint associated with the data access request is not pinned to the customer account associated the data access request, the data access request is rejected to prevent unauthorized access.

In some examples, the data platform extracts a request private endpoint identifier and a request customer account identifier from a header of the data access request, queries the private account mapping data persistence object using the extracted request private endpoint identifier and the extracted request customer account identifier to determine if the private endpoint is pinned to the customer account. To do so, the request processing service 208 extracts the private endpoint identifier from the data access request header. The private endpoint identifier can be a link identifier, VPCE-ID, or the like depending on the cloud service provider. The request processing service 208 queries the private account mapping data persistence object 238 using the extracted request private endpoint identifier to obtain a set of customer accounts to which the private endpoint indicated by the request private endpoint identifier. The request processing service 208 compares the extracted request customer account identifier with each customer account of the set of customer accounts to find a match. This verification step checks whether the private endpoint identifier associated with the data access request is bound to the requested customer account. This process leverages the pinning created during the registration of private endpoints pinned to customer accounts, which is stored in the pinned consumer endpoint account mapping slice 230 and the private endpoints by account slice 236 of the private account mapping data persistence object 238.

In some examples, the data platform implements a time-limited caching mechanism to improve performance and efficiency of the private endpoint pinning solution. The data platform uses a time-limited cache to store the mapping from the private endpoint identifier to the customer account identifier. This approach helps lower the probability of causing transactions to expire when verifying the pinning between private endpoints and customer accounts. In some examples, the data platform opts for a local cache instead of other caching options as the key for the cache can be the external private endpoint identifier rather than a data persistent object. This caching approach helps optimize the additional verification step required for each request originating from the private endpoint, balancing security needs with performance considerations.

In some examples, the data platform implements a caching mechanism to store frequently accessed registrations in a time-limited cache. This approach helps optimize performance by reducing the need to repeatedly retrieve data from a private account mapping data persistence object for each verification request. For example, the data platform can utilize a 1-minute local cache to store mappings from private link endpoint IDs to account IDs. This caching strategy lowers the probability of causing transactions to expire during the additional verification step required for each request originating from a private endpoint. When loading the cache, the data platform compares the current timestamp with the enforcement timestamp stored in the private account mapping data persistence object to determine if the enforcement should be applied. By implementing this time-limited caching mechanism, the data platform balances the need for up-to-date information with improved response times and reduced load on the underlying data storage systems.

In some examples, the data platform implements a private endpoint pinning process in a multi-cloud environment using cloud-specific identifiers and authentication mechanisms. For an example cloud service provider, the data platform uses VPCE-ID as the private endpoint identifier and generates a federation token with specific permissions to describe VPC endpoints. For another example cloud service provider, the data platform uses a link identifier as the private endpoint identifier and generates an access token that can access the private endpoint resource. The data platform verifies ownership and access privileges using these cloud-specific tokens during the registration process. When processing data access requests, the data platform extracts the cloud-specific private endpoint identifier provided by the cloud service from a data access request header. This approach allows the data platform to maintain a consistent private endpoint pinning solution while accommodating the unique characteristics and authentication methods of different cloud environments.

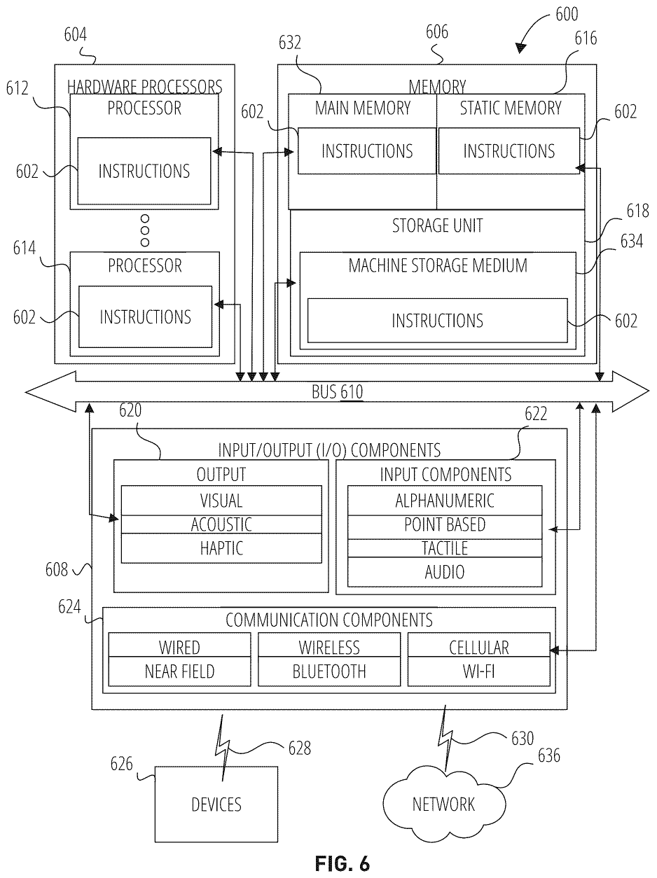

FIG. 6 illustrates a diagrammatic representation of a machine 600 in the form of a computer system within which a set of instructions may be executed for causing the machine 600 to perform any one or more of the methodologies discussed herein, according to examples. Specifically, FIG. 6 shows a diagrammatic representation of the machine 600 in the example form of a computer system, within which instructions 602 (e.g., software, a program, an application, an applet, an application, or other executable code) for causing the machine 600 to perform any one or more of the methodologies discussed herein may be executed. For example, the instructions 602 may cause the machine 600 to execute any one or more operations of any one or more of the methods described herein. In this way, the instructions 602 transform a general, non-programmed machine into a particular machine 600 (e.g., the compute service manager 104, the execution platform 110, and the virtual private clouds 108-1 to 108-N of cloud service 106) that is specially configured to carry out any one of the described and illustrated functions in the manner described herein.

In alternative examples, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 602, sequentially or otherwise, that specify actions to be taken by the machine 600. Further, while only a single machine 600 is illustrated, the term “machine” shall also be taken to include a collection of machines that individually or jointly execute the instructions 602 to perform any one or more of the methodologies discussed herein.

The machine 600 includes hardware processors 604, memory 606, and I/O components 608 configured to communicate with each other such as via a bus 610. In some examples, the hardware processors 604 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another hardware processor, or any suitable combination thereof) may include, for example, multiple processors as exemplified by processor 612 and a processor 614 that may execute the instructions 602. The term “processor” is intended to include multi-core processors that may comprise two or more independent processors (sometimes referred to as “cores”) that may execute instructions 602 contemporaneously. Although FIG. 6 shows multiple hardware processors 604, the machine 600 may include a single processor with a single core, a single processor with multiple cores (e.g., a multi-core processor), multiple processors with a single core, multiple processors with multiple cores, or any combination thereof.

The memory 606 may include a main memory 632, a static memory 616, and a storage unit 618 including a machine storage medium 634, accessible to the hardware processors 604 such as via the bus 610. The main memory 632, the static memory 616, and the storage unit 618 store the instructions 602 embodying any one or more of the methodologies or functions described herein. The instructions 602 may also reside, completely or partially, within the main memory 632, within the static memory 616, within the storage unit 618, within at least one of the hardware processors 604 (e.g., within the processor's cache memory), or any suitable combination thereof, during execution thereof by the machine 600.

As used herein, the terms “machine-storage medium,” “device-storage medium,” and “computer-storage medium” mean the same thing and may be used interchangeably in this disclosure. The terms refer to a single or multiple storage systems, devices, and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage storage medium,” “computer-storage storage medium,” and “device-storage storage medium” specifically exclude carrier waves, modulated data signals, and other such media, at least some of which are covered under the term “signal medium” discussed below.

The input/output (I/O) components 608 include components to receive input, provide output, produce output, transmit information, exchange information, capture measurements, and so on. The specific I/O components 608 that are included in a particular machine 600 will depend on the type of machine. For example, portable machines such as mobile phones will likely include a touch input device or other such input mechanisms, while a headless server machine will likely not include such a touch input device. It will be appreciated that the I/O components 608 may include many other components that are not shown in FIG. 6. The I/O components 608 are grouped according to functionality merely for simplifying the following discussion and the grouping is in no way limiting. In various examples, the I/O components 608 may include output components 620 and input components 622. The output components 620 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 622 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 608 may include communication components 624 operable to couple the machine 600 to a network 636 or devices 626 via a coupling 630 and a coupling 628, respectively. For example, the communication components 624 may include a network interface component or another suitable device to interface with the network 636. In further examples, the communication components 624 may include wired communication components, wireless communication components, cellular communication components, and other communication components to provide communication via other modalities. The devices 626 may be another machine or any of a wide variety of peripheral devices (e.g., a peripheral device coupled via a Universal Serial Bus (USB)). For example, as noted above, the machine 600 may correspond to any one of the compute service manager 104, the execution platform 110, and the devices 626 may include the data storage system 226 or any other computing device described herein as being in communication with the data platform 102 or the cloud service 106 of FIG. 1.

The various memories (e.g., 606, 616, 632, and/or memory of the processor(s) 604 and/or the storage unit 618) may store one or more sets of instructions 602 and data structures (e.g., software) embodying or utilized by any one or more of the methodologies or functions described herein. These instructions 602, when executed by the processor(s) 604, cause various operations to implement the disclosed examples.

In various examples, one or more portions of the network 636 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 636 or a portion of the network 636 may include a wireless or cellular network, and the coupling 630 may be a Code Division Multiple Access (CDMA) connection, a Global System for Mobile communications (GSM) connection, or another type of cellular or wireless coupling. In this example, the coupling 630 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 602 may be transmitted or received over the network 636 using a transmission medium via a network interface device (e.g., a network interface component included in the communication components 624) and utilizing any one of a number of well-known transfer protocols (e.g., hypertext transfer protocol (HTTP)). Similarly, the instructions 602 may be transmitted or received using a transmission medium via the coupling 628 (e.g., a peer-to-peer coupling) to the devices 626. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 602 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Described implementations of the subject matter can include one or more features, alone or in combination as illustrated below by way of example:

Example 1 is a machine-implemented method, comprising: providing a private endpoint service for a set of customer accounts within a database deployment; receiving a request to register a private endpoint of the private endpoint service with a customer account of the set of customer accounts; verifying ownership and access privileges of the private endpoint; pinning the private endpoint to the customer account by registering the pinning in a private account mapping data persistence object; receiving, from the private endpoint, a data access request for access to the customer account; verifying the pinning between the private endpoint and the customer account using the registration; and allowing the data access request based on the verifying of the pinning.

In Example 2, the subject matter of Example 1 includes, wherein verifying the ownership and access privileges comprises: receiving a federated token from a customer of the customer account; validating the federated token using a cloud-specific authentication; and confirming that the token grants access to the private endpoint.

In Example 3, the subject matter of Examples 1-2 includes, providing system-level functions for managing private endpoint registrations, the system-level functions including at least one of a private endpoint registration function, an unregister private endpoint function, and a get private endpoint registration function.

In Example 4, the subject matter of any of Examples 1-3 includes, wherein creating the pinning comprises: associating a cloud-specific identifier of the private endpoint with a customer account identifier of the customer account.

In Example 5, the subject matter of any of Examples 1-4 includes, delaying enforcement of the pinning using a specified time period between registering the pinning and enforcement of the pinning.

In Example 6, the subject matter of any of Example 5 includes, receiving a delay time parameter from the customer during a registration process; calculating an enforcement timestamp based on a current time and the delay time parameter; and activating the enforcement of the pinning on a per-customer basis when the current time exceeds the enforcement timestamp.

In Example 7, the subject matter of any of Examples 1-6 includes, wherein verifying the pinning between the private endpoint and the customer account comprises: extracting a request private endpoint identifier and a request customer account identifier from a header of the data access request; and querying the private account mapping data persistence object using the request private endpoint identifier and the request customer account identifier to determine the request private endpoint identifier is pinned to the request customer account identifier.

In Example 8, the subject matter of any of Examples 1-7 includes, caching frequently accessed registrations in a time-limited cache.

In Example 9, the subject matter of any of Examples 1-8 includes, wherein a cloud-specific identifier and authentication processes is used for the private endpoint in a multi-cloud environment.

In Example 10, the subject matter of any of Examples 1-9 includes, wherein the private account mapping data persistence object comprises: a first slice for mapping pinned consumer endpoint identifiers to customer account identifiers; and a second slice for mapping customer account identifiers to pinned consumer endpoint identifiers.

Example 11 is at least one machine-readable medium including instructions that, when executed by processing circuitry, cause the processing circuitry to perform operations to implement any of Examples 1-10.

Example 12 is an apparatus comprising means to implement any of Examples 1-10.

Example 13 is a system to implement any of Examples 1-10.

Example 14 is a method to implement any of Examples 1-10.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

1. A machine-implemented method, comprising:
providing a private endpoint service for a set of customer accounts within a database deployment;
receiving a request to register a private endpoint of the private endpoint service with a customer account of the set of customer accounts;
verifying ownership and access privileges of the private endpoint;
pinning the private endpoint to the customer account by registering the pinning in a private account mapping data persistence object;
receiving, from the private endpoint, a data access request for access to the customer account;
verifying the pinning between the private endpoint and the customer account using the private account mapping data persistence object; and
allowing the data access request based on the verifying of the pinning.

2. The machine-implemented method of claim 1, wherein verifying the ownership and access privileges comprises:
receiving a federated token from a customer of the customer account;
validating the federated token using a cloud-specific authentication; and
confirming that the token grants access to the private endpoint.

3. The machine-implemented method of claim 1, further comprising:
providing system-level functions for managing private endpoint registrations, the system-level functions including at least one of: a private endpoint registration function, an unregister private endpoint function, and a get private endpoint registration function.

4. The machine-implemented method of claim 1, wherein creating the pinning comprises:
associating a cloud-specific identifier of the private endpoint with a customer account identifier of the customer account.

5. The machine-implemented method of claim 1, further comprising:
delaying enforcement of the pinning using a specified time period.

6. The machine-implemented method of claim 5, further comprising:
receiving a delay time parameter from the customer during a registration process;
calculating an enforcement timestamp based on a current time and the delay time parameter; and
activating the enforcement of the pinning on a per-customer basis when the current time exceeds the enforcement timestamp.

7. The machine-implemented method of claim 1, wherein verifying the pinning between the private endpoint and the customer account comprises:
extracting a request private endpoint identifier and a request customer account identifier from a header of the data access request; and
querying the private account mapping data persistence object using the request private endpoint identifier and the request customer account identifier to determine the request private endpoint identifier is pinned to the request customer account identifier.

8. The machine-implemented method of claim 1, further comprising:
caching frequently accessed registrations in a time-limited cache.

9. The machine-implemented method of claim 1, wherein a cloud-specific identifier and authentication processes is used for the private endpoint in a multi-cloud environment.

10. The machine-implemented method of claim 1, wherein the private account mapping data persistence object comprises:
a first slice mapping pinned consumer endpoint identifiers to customer account identifiers; and
a second slice mapping customer account identifiers to pinned consumer endpoint identifiers.

11. A system comprising:
at least one processor; and
at least one memory storing instructions that, when executed by the at least one processor, cause the system to perform operations comprising:
providing a private endpoint service for a set of customer accounts within a database deployment;
receiving a request to register a private endpoint of the private endpoint service with a customer account of the set of customer accounts;
verifying ownership and access privileges of the private endpoint;
pinning the private endpoint to the customer account by registering the pinning in a private account mapping data persistence object;
receiving, from the private endpoint, a data access request for access to the customer account;
verifying the pinning between the private endpoint and the customer account using the private account mapping data persistence object; and
allowing the data access request based on the verifying of the pinning.

12. The system of claim 11, wherein verifying the ownership and access privileges comprises:
receiving a federated token from a customer of the customer account;
validating the federated token using a cloud-specific authentication; and
confirming that the token grants access to the private endpoint.

13. The system of claim 11, wherein the operations further comprise:
providing system-level functions for managing private endpoint registrations, the system-level functions including at least one of: a private endpoint registration function, an unregister private endpoint function, and a get private endpoint registration function.

14. The system of claim 11, wherein creating the pinning comprises:
associating a cloud-specific identifier of the private endpoint with a customer account identifier of the customer account.

15. The system of claim 11, wherein the operations further comprise:
delaying enforcement of the pinning using a specified time period.

16. The system of claim 15, wherein the operations further comprise:
receiving a delay time parameter from the customer during a registration process;
calculating an enforcement timestamp based on a current time and the delay time parameter; and
activating the enforcement of the pinning on a per-customer basis when the current time exceeds the enforcement timestamp.

17. The system of claim 11, wherein verifying the pinning between the private endpoint and the customer account comprises:
extracting a request private endpoint identifier and a request customer account identifier from a header of the data access request; and
querying the private account mapping data persistence object using the request private endpoint identifier and the request customer account identifier to determine the request private endpoint identifier is pinned to the request customer account identifier.

18. The system of claim 11, wherein the operations further comprise:
caching frequently accessed registrations in a time-limited cache.

19. The system of claim 11, wherein a cloud-specific identifier and authentication processes is used for the private endpoint in a multi-cloud environment.

20. The system of claim 11, wherein the private account mapping data persistence object comprises:
a first slice mapping pinned consumer endpoint identifiers to customer account identifiers; and
a second slice mapping customer account identifiers to pinned consumer endpoint identifiers.

21. A machine-storage medium storing instructions that, when executed by one or more processors of a system, cause the system to perform operations comprising:
providing a private endpoint service for a set of customer accounts within a database deployment;
receiving a request to register a private endpoint of the private endpoint service with a customer account of the set of customer accounts;
verifying ownership and access privileges of the private endpoint;
pinning the private endpoint to the customer account by registering the pinning in a private account mapping data persistence object;
receiving, from the private endpoint, a data access request for access to the customer account;
verifying the pinning between the private endpoint and the customer account using the private account mapping data persistence object; and
allowing the data access request based on the verifying of the pinning.

22. The machine-storage medium of claim 21, wherein verifying the ownership and access privileges comprises:
receiving a federated token from a customer of the customer account;
validating the federated token using a cloud-specific authentication; and
confirming that the token grants access to the private endpoint.

23. The machine-storage medium of claim 21, wherein the operations further comprise:
providing system-level functions for managing private endpoint registrations, the system-level functions including at least one of: a private endpoint registration function, an unregister private endpoint function, and a get private endpoint registration function.

24. The machine-storage medium of claim 21, wherein creating the pinning comprises:
associating a cloud-specific identifier of the private endpoint with a customer account identifier of the customer account.

25. The machine-storage medium of claim 21, wherein the operations further comprise:
delaying enforcement of the pinning using a specified time period.

26. The machine-storage medium of claim 25, wherein the operations further comprise:
receiving a delay time parameter from the customer during a registration process;
calculating an enforcement timestamp based on a current time and the delay time parameter; and
activating the enforcement of the pinning on a per-customer basis when the current time exceeds the enforcement timestamp.

27. The machine-storage medium of claim 21, wherein verifying the pinning between the private endpoint and the customer account comprises:
extracting a request private endpoint identifier and a request customer account identifier from a header of the data access request; and
querying the private account mapping data persistence object using the request private endpoint identifier and the request customer account identifier to determine the request private endpoint identifier is pinned to the request customer account identifier.

28. The machine-storage medium of claim 21, wherein the operations further comprise:
caching frequently accessed registrations in a time-limited cache.

29. The machine-storage medium of claim 21, wherein a cloud-specific identifier and authentication processes is used for the private endpoint in a multi-cloud environment.

30. The machine-storage medium of claim 21, wherein the private account mapping data persistence object comprises:
a first slice mapping pinned consumer endpoint identifiers to customer account identifiers; and
a second slice mapping customer account identifiers to pinned consumer endpoint identifiers.
